(19) United States
(12) Patent Application Publication
(10) Pub. No.: US 2024/0201107 A1
(43) Pub. Date: Jun. 20, 2024

(54) CONTACTLESS AND WIRELESS DEVICE FOR MEASURING SOLUTION CONCENTRATION

(71) Applicant: SOOCHOW UNIVERSITY, Suzhou (CN)

(72) Inventors: Yunjing ZHANG, Suzhou (CN); Peng LI, Suzhou (CN); Xingli HE, Suzhou (CN); Yujiang DOU, Suzhou (CN); Lingfeng LI, Suzhou (CN)

(21) Appl. No.: 17/910,761

(22) PCT Filed: Oct. 12, 2021
(86) PCT No.: PCT/CN2021/123251

§ 371 Date: Sep. 9, 2022

(30) Foreign Application Priority Data
Aug. 20, 2021 (CN) 202110963141.3

(51) Int. Cl. G01N 22/00; H01P 5/22; H01Q 1/38; H01Q 13/10; H01Q 21/24

(52) U.S. Cl. CPC G01N 22/00; H01P 5/22; H01Q 13/106; H01Q 21/24; H01Q 1/38

(57) ABSTRACT

The present invention discloses a contactless and wireless device for measuring solution concentration, including: a measuring machine including a vertical polarization antenna, a horizontal polarization antenna and a contactless measurement means for containing solution to be measured, the contactless measurement means including a liquid container and a microstrip defected ground structure (DGS), the liquid container being disposed on the microstrip DGS, the microstrip DGS including a microstrip line and a double split ring resonator; and a transceiver unit including a transceiver and a dual-polarization receive-transmit antenna connected in communication. In the contactless and wireless device for measuring solution concentration according to the present invention, a double split ring resonator structure is used to detect variation of the solution concentration with high accuracy. The present invention enables contactless telemetry measurement of variation of the solution concentration with higher sensitivity than conventional microwave noninvasive measurement methods.

### FIELD OF THE INVENTION

The present invention relates to the technical field of solution concentration measurement, and more particularly to a contactless and wireless device for measuring solution concentration.

### DESCRIPTION OF THE RELATED ART

At present, methods for measuring solution concentration include specific gravity method, polarimetric method, spectrophotometric method, ultrasonic method and refractive index method. The specific gravity method has the highest accuracy, but it is not suitable for rapid field detection. The polarimetric method is related to the composition of the solution, and has limited application range. Although ultrasonic method and refractive index method can be well used for non-invasive detection, the accuracy depends on complex processing equipment, which not only has high cost, but also has rather limited range of applicable frequency band.

### SUMMARY OF THE INVENTION

The technical solution to be addressed by the present invention is to provide a contactless and wireless device for measuring solution concentration that enables wireless measurement and has high sensitivity.

To address the problem mentioned above, the present invention provides a contactless and wireless device for measuring solution concentration including:
a measuring machine including a vertical polarization antenna, a horizontal polarization antenna and a contactless measurement means for containing solution to be measured, the contactless measurement means including a liquid container and a microstrip defected ground structure (DGS), the liquid container being disposed on the microstrip DGS, the liquid container having an inlet and an outlet, the microstrip DGS including a microstrip line and a double split ring resonator, the ends of the microstrip line forming a first port and a second port respectively, the vertical polarization antenna being connected to the first port, the horizontal polarization antenna being connected to the second port; and
a transceiver unit including a transceiver and a dual-polarization receive-transmit antenna connected in communication;
in which the transceiver transmits a vertical polarization continuous wave signal via the dual-polarization receive-transmit antenna, the vertical polarization antenna receives the vertical polarization continuous wave signal, the vertical polarization continuous wave signal passes through the solution to be measured and then is converted into a horizontal polarization continuous wave signal by the horizontal polarization antenna, the dual-polarization receive-transmit antenna receives the horizontal polarization continuous wave signal, to obtain a power ratio S21 between the horizontal polarization continuous wave signal and the vertical polarization continuous wave signal, and the concentration of the solution to be measured is calculated according to the variation of the resonance point of S21.

As a further improvement of the present invention, the width of slot is greater than the width of opening in the double split ring resonator.

As a further improvement of the present invention, the width of slot in the double split ring resonator is 0.1-0.5 mm and the width of opening in the double split ring resonator is 0.05-0.1 mm.

As a further improvement of the present invention, the relationship between the power of the horizontal polarization continuous wave signal and the telemetry distance is as follows:

$$R \leq \frac{λ}{4 π} \sqrt{\frac{{P}_{t} {G}_{t} {G}_{r}}{{P}_{s}}}$$

where R is the telemetry distance, λ is the wavelength corresponding to the operating frequency, Pₜ is the transmit power of the transceiver, Gₜ and Gᵣ are the gain values of the transceiver and the measuring machine antenna respectively, and Pₛ is the lowest operable power of the measuring machine.

As a further improvement of the present invention, the frequency band of the vertical polarization continuous wave signal is 1-2 GHZ.

As a further improvement of the present invention, the width of the microstrip line is greater than the width of opening in the double split ring resonator.

As a further improvement of the present invention, the liquid container has an inlet and the outlet that are disposed symmetrically on both sides of the liquid container.

As a further improvement of the present invention, the characteristic impedance of the microstrip line is 50 Ohm.

As a further improvement of the present invention, the liquid container is made of quartz glass.

The present invention further provides a contactless and wireless device for measuring solution concentration, including:
a measuring machine including a vertical polarization antenna, a horizontal polarization antenna, a circulator, a load and a contactless measurement means for containing solution to be measured, the contactless measurement means including a liquid container and a microstrip defected ground structure (DGS), the liquid container being disposed on the microstrip DGS, the liquid container having an inlet and an outlet, the microstrip DGS including a microstrip line and a double split ring resonator, the width of the microstrip line being greater than the width of opening in the double split ring resonator, the ends of the microstrip line forming a first port and a second port respectively, the vertical polarization antenna and the vertical polarization antenna being connected to the first port via the circulator, the second port being connected to the load; and
a transceiver unit including a transceiver and a dual-polarization receive-transmit antenna connected in communication;
in which the transceiver transmits a vertical polarization continuous wave signal via the dual-polarization receive-transmit antenna, the vertical polarization antenna receives the vertical polarization continuous wave signal, the vertical polarization continuous wave signal enters the solution to be measured via the circulator and is then returned into the circulator, and is converted into a horizontal polarization continuous wave signal by the horizontal polarization antenna, the dual-polarization receive-transmit antenna receives the horizontal polarization continuous wave signal, to obtain a power ratio S11 between the horizontal polarization continuous wave signal and the vertical polarization continuous wave signal, and the concentration of the solution to be measured is calculated according to the variation of the resonance point of S11.

The present invention has the following beneficial effects:

In the contactless and wireless device for measuring solution concentration according to the present invention, a double split ring resonator is used to detect variation of the solution concentration with high accuracy. The present invention enables contactless telemetry measurement of variation of the solution concentration with higher sensitivity than conventional microwave noninvasive measurement methods.

The above description is only a summary of the technical solution of the present invention. In order to understand the technical means of the present invention more clearly, it can be implemented according to the contents of the specification. In order to make the above and other objects, features and advantages of the present invention more obvious and understandable, preferred embodiments will be described in detail in the following with reference to the accompanying drawings.

### BRIEF DESCRIPTION OF THE DRAWINGS

FIG. 1 is a schematic view of a contactless and wireless device for measuring solution concentration according to a first preferred embodiment of the present invention;

FIG. 2 is a schematic view showing the external structure of a contactless measurement means according to a first preferred embodiment of the present invention;

FIG. 3 is a schematic view showing a microstrip DGS according to a first preferred embodiment of the present invention;

FIG. 4 is an equivalent circuit diagram of a contactless measurement means according to the present invention;

FIG. 5 is a schematic view showing contactless and wireless device for measuring solution concentration according to a second preferred embodiment of the present invention;

FIG. 6 shows the changing curve of the S11 value for glucose solutions with various concentrations according to a preferred embodiment of the present invention;

FIG. 7 shows the changing curve of the resonance point of S11 for glucose solutions with various concentrations according to a preferred embodiment of the present invention;

FIG. 8 shows the changing curve of the S21 value for glucose solutions with various concentrations according to a preferred embodiment of the present invention; and

FIG. 9 shows the changing curve of the resonance point of S21 for glucose solutions with various concentrations according to a preferred embodiment of the present invention.

Reference Numerals: 10 liquid container; 11 inlet; 12 outlet; 20 microstrip DGS; 21 dielectric slab; 22 microstrip line; 23 double split ring resonator

### DETAILED DESCRIPTION OF THE PREFERRED EMBODIMENTS

The invention will be further explained with reference to the following drawings and particular embodiments, so that those skilled in the art can better understand the present invention and implement it. However, the listed embodiments should not be taken as limitation of the present invention.

The dielectric constant ε of the solution concentration can be accurately characterized by the Debye model:

$$ε ( ω ) = {ε}^{′} - j {ε}^{″} = {ε}_{∞} + \frac{{ε}_{S} - {ε}_{∞}}{1 + j ωτ}$$

where ε′ is the real part of the dielectric constant of the solution and ε″ is the imaginary part of the dielectric constant, ε_{∞} is the dielectric constant at a frequency of an infinite value, εₛ is the dielectric constant in a direct current field, τ is the relaxation time of the solution, j is the imaginary unit and ω is the angular frequency. When the solution concentration varies, there is a linear relationship between the parameters above and the concentration variation. Therefore, variation of the solution concentration can be detected by detecting variation of the dielectric constant.

### Embodiment 1

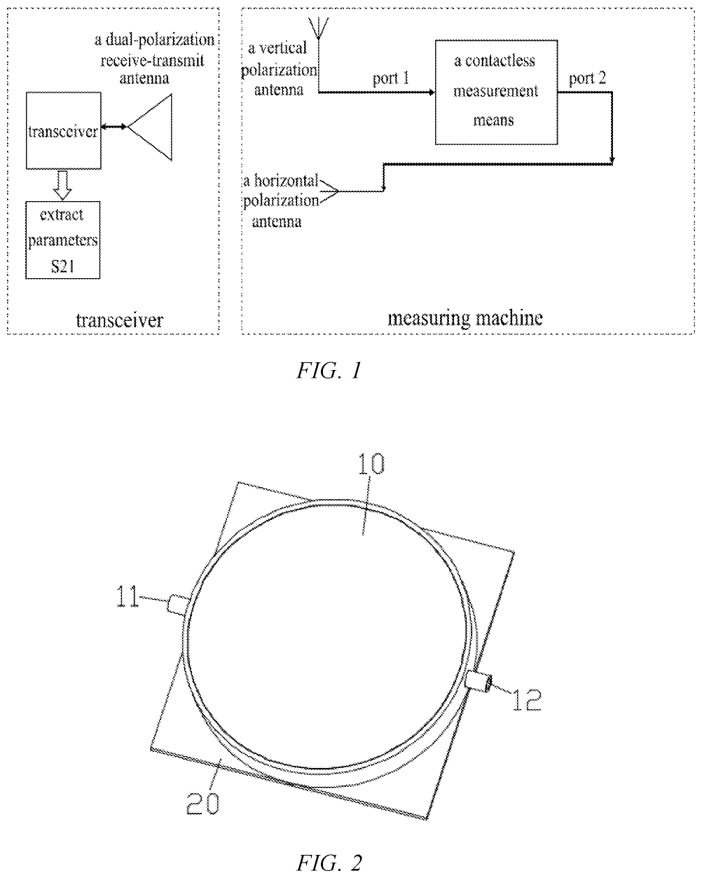

As shown in FIGS. 1-3, a contactless and wireless device for measuring solution concentration according to a first embodiment of the present invention includes:
a measuring machine including a vertical polarization antenna, a horizontal polarization antenna and a contactless measurement means for containing solution to be measured, wherein the contactless measurement means includes a liquid container 10 and a microstrip defected ground structure (DGS) 20, the liquid container 10 is disposed on the microstrip DGS 20, the liquid container 10 has an inlet 11 and an outlet 12, the microstrip DGS 20 includes a microstrip line 22 and a double split ring resonator 23, two ends of the microstrip line 22 form a first port and a second port respectively, the vertical polarization antenna is connected to the first port, the horizontal polarization antenna is connected to the second port; and
a transceiver unit including a transceiver and a dual-polarization receive-transmit antenna connected in communication.

The transceiver transmits a vertical polarization continuous wave signal via the dual-polarization receive-transmit antenna, the vertical polarization antenna receives the vertical polarization continuous wave signal, the vertical polarization continuous wave signal passes through the solution to be measured and then is converted into a horizontal polarization continuous wave signal by the horizontal polarization antenna, the dual-polarization receive-transmit antenna receives the horizontal polarization continuous wave signal, to obtain a power ratio S21 between the horizontal polarization continuous wave signal and the vertical polarization continuous wave signal, and the concentration of the solution to be measured is calculated according to the variation of the resonance point of S21. The contactless and wireless device for measuring solution concentration further includes a processor to perform computation on the data.

Optionally, the liquid container 10 is of a circular shape having a radius and wall thickness that can be determined according to the requirements. The solution to be measured enters the container via the inlet 11 and flows out via the outlet 12. As such, an online measurement system is formed.

The equivalent circuit of the contactless measurement means as shown in FIG. 4 can be obtained from the microwave theory. When the solution concentration varies, its equivalent capacitance Cs, inductance Ls and resistance Rs also vary. When the size of slot in the double split ring resonator varies, its equivalent capacitance Cr and inductance Lr vary accordingly. As such, after the above values are optimized, it can be provided that the equivalent circuit has the minimum reflection at a certain frequency f in a certain frequency band, that is, |S11| is smallest, or the loss is greatest, that is, |S21| is smallest, at which time f is called the transmission resonance point. At this time, when the solution concentration changes, the equivalent circuit value of the solution to be measured changes, so that the transmission resonance point is changed by Δf. Therefore, variation of the solution concentration can be measured through Δf.

In this embodiment, the characteristic impedance of the microstrip line 22 is 50 Ohm. The microstrip line 22 is etched on the dielectric slab 21. The width of the microstrip line 22 can be determined according to the dielectric constant of the dielectric slab 21.

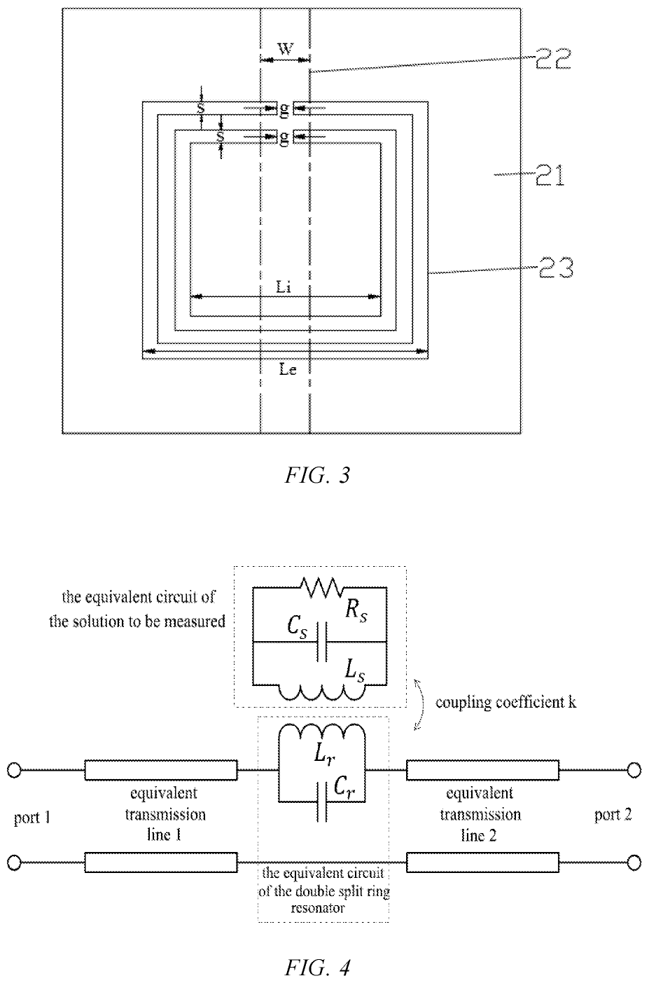

As shown in FIG. 3, the length of the internal ring of the double split ring resonator 23 is Li and the length of the external ring is Le (the optimum value is about 0.05 times the operating wavelength).

The slot width s is greater than the opening width g in the double split ring resonator 23. Optionally, the slot width s in the double split ring resonator 23 is 0.1-0.5 mm and the opening width g in the double split ring resonator 23 is 0.05-0.1 mm.

Preferably, the width W of the microstrip line 22 is greater than the opening width g in the double split ring resonator 23. The smaller g is than W, the higher sensitivity the double split ring resonator 23 has.

The relationship between the power of the horizontal polarization continuous wave signal and the telemetry distance is as follows:

$$R \leq \frac{λ}{4 π} \sqrt{\frac{{P}_{t} {G}_{t} {G}_{r}}{{P}_{s}}}$$

where R is the telemetry distance, λ is the wavelength corresponding to the operating frequency, Pₜ is the transmit power of the transceiver, Gₜ and Gᵣ are the gain values of the transceiver and the measuring machine antenna respectively, and Pₛ is the lowest operable power of the measuring machine.

Optionally, the frequency band of the vertical polarization continuous wave signal is 1-2 GHZ.

Optionally, the inlet 11 and the outlet 12 are disposed symmetrically on both sides of the liquid container 10.

Optionally, the liquid container 10 is made of quartz glass.

### Embodiment 2

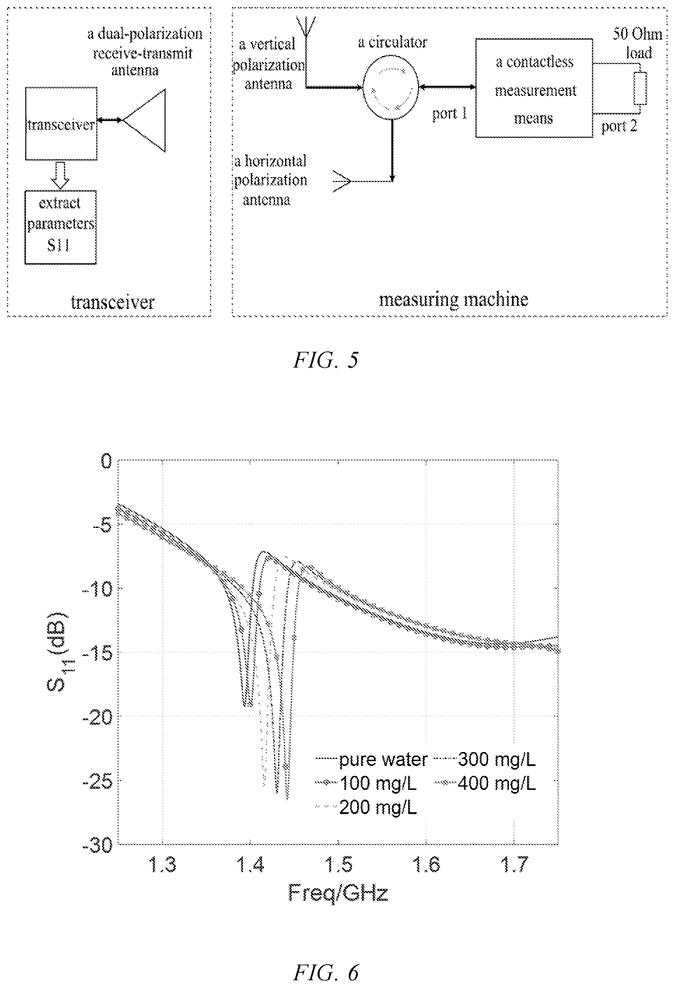

FIG. 5 shows a contactless and wireless device for measuring solution concentration according to a second embodiment of the present invention, including:
a measuring machine including a vertical polarization antenna, a horizontal polarization antenna, a circulator, a load and a contactless measurement means for containing solution to be measured, wherein the contactless measurement means includes a liquid container 10 and a microstrip defected ground structure (DGS) 20, the liquid container 10 is disposed on the microstrip DGS 20, the liquid container 10 has an inlet 11 and an outlet 12, the microstrip DGS 20 includes a microstrip line 22 and a double split ring resonator 23, the width of the microstrip line 22 is greater than the width of opening in the double split ring resonator 23, the two ends of the microstrip line 22 form a first port and a second port respectively, the vertical polarization antenna and the vertical polarization antenna are connected to the first port via the circulator, the second port is connected to the load; and
a transceiver unit including a transceiver and a dual-polarization receive-transmit antenna connected in communication.

The transceiver transmits a vertical polarization continuous wave signal via the dual-polarization receive-transmit antenna, the vertical polarization antenna receives the vertical polarization continuous wave signal, the vertical polarization continuous wave signal enters the solution to be measured via the circulator and is then returned into the circulator, and is converted into a horizontal polarization continuous wave signal by the horizontal polarization antenna, the dual-polarization receive-transmit antenna receives the horizontal polarization continuous wave signal, to obtain a power ratio S11 between the horizontal polarization continuous wave signal and the vertical polarization continuous wave signal, and the concentration of the solution to be measured is calculated according to the variation of the resonance point of S11. The contactless and wireless device for measuring solution concentration further includes a processor to perform computation on the data.

In this embodiment, the load is 50 Ohm.

The specific structure and principle of the contactless measurement means in this embodiment are the same as in the first embodiment and shall not be described again herein.

In a particular embodiment, glucose solution is detected by using the contactless and wireless device for measuring solution concentration according to the present invention, and the concentration of the solution to be measured is 0, 100, 200, 300, 400 and 500 mg/dL, respectively.

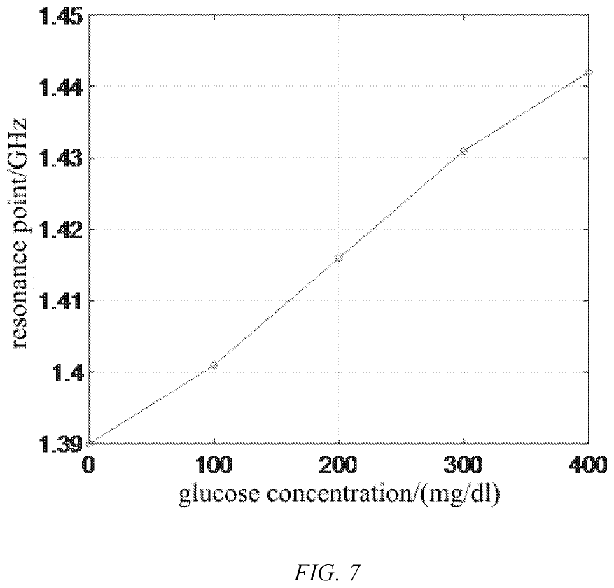

FIG. 6 shows the changing curve of the S11 value for glucose solutions with various concentrations according to a preferred embodiment of the present invention. As can be seen, when the solution is pure water (0 mg/dL), its S11 resonance point occurs at about 1.39 GHz, and as the glucose concentration in the solution changes, its resonance point is incremented. FIG. 7 shows the changing curve of the resonance point of S11 for glucose solutions with various concentrations according to a preferred embodiment of the present invention. As can be seen, the average measurement sensitivity has reached 12 MHz/(100 mg/dL), which shows that the method of the present invention has excellent sensitivity compared with conventional methods.

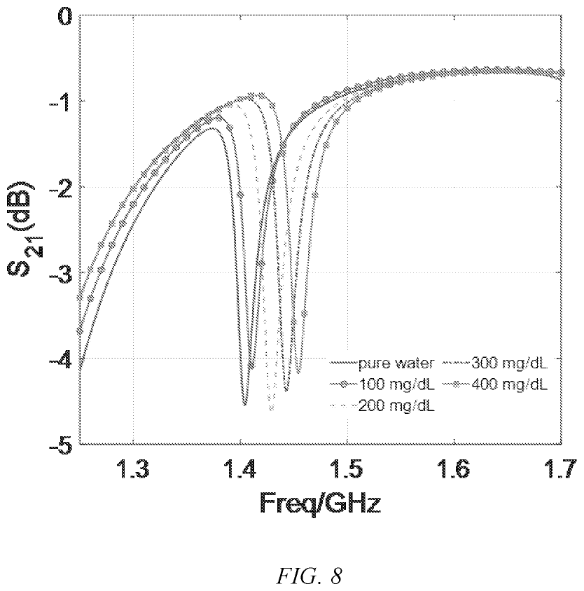

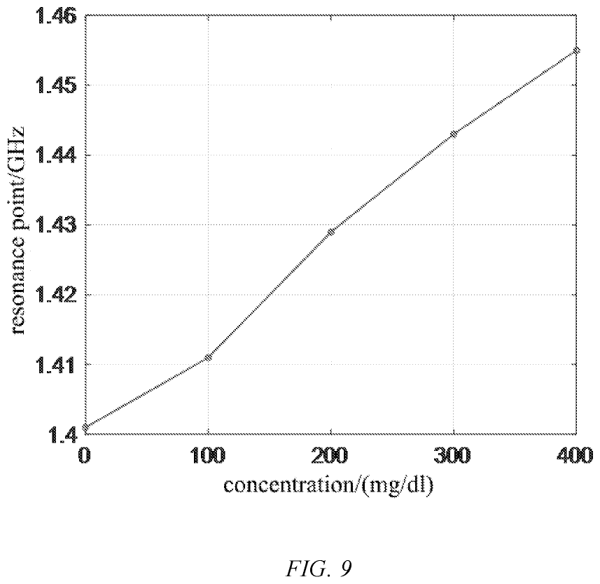

FIG. 8 shows the changing curve of the S21 value for glucose solutions with various concentrations according to a preferred embodiment of the present invention. As can be seen, when the solution is pure water, its resonance point of S21 occurs at about 1.40 GHz, and as the glucose concentration in the solution changes, its resonance point is incremented. FIG. 9 shows the changing curve of the resonance point of S21 for glucose solutions with various concentrations according to a preferred embodiment of the present invention. As can be seen, the average measurement sensitivity has reached 13 MHz/(100 mg/dL), which shows that the method of the present invention has excellent sensitivity compared with conventional methods.

The above embodiments are only preferred embodiments for fully explaining the present invention, and the scope of protection of the present invention is not limited thereto. Equivalent substitutions or changes made by those skilled in the art on the basis of the present invention shall fall within the scope of protection of the present invention. The scope of protection of the invention is defined by the claims.

What is claimed is:

1. A contactless and wireless device for measuring solution concentration, comprising:
a measuring machine including a vertical polarization antenna, a horizontal polarization antenna and a contactless measurement means for containing solution to be measured, the contactless measurement means including a liquid container and a microstrip defected ground structure, the liquid container being disposed on the microstrip defected ground structure, the liquid container having an inlet and an outlet, the microstrip defected ground structure including a microstrip line and a double split ring resonator, two ends of the microstrip line forming a first port and a second port respectively, the vertical polarization antenna being connected to the first port, the horizontal polarization antenna being connected to the second port; and
a transceiver unit including a transceiver and a dual-polarization receive-transmit antenna connected in communication;
wherein the transceiver transmits a vertical polarization continuous wave signal via the dual-polarization receive-transmit antenna, the vertical polarization antenna receives the vertical polarization continuous wave signal, the vertical polarization continuous wave signal passes through the solution to be measured and then is converted into a horizontal polarization continuous wave signal by the horizontal polarization antenna, the dual-polarization receive-transmit antenna receives the horizontal polarization continuous wave signal, to obtain a power ratio S21 between the horizontal polarization continuous wave signal and the vertical polarization continuous wave signal, and the concentration of the solution to be measured is calculated according to the variation of a resonance point of S21.

2. The device of claim 1, wherein a width of slot is greater than a width of opening in the double split ring resonator.

3. The device of claim 2, wherein the width of slot in the double split ring resonator is 0.1-0.5 mm and the width of opening in the double split ring resonator is 0.05-0.1 mm.

4. The device of claim 1, wherein a relationship between the power of the horizontal polarization continuous wave signal and the telemetry distance is:
$$R \leq \frac{λ}{4 π} \sqrt{\frac{{P}_{t} {G}_{t} {G}_{r}}{{P}_{s}}}$$
where R is a telemetry distance, λ is a wavelength corresponding to an operating frequency, Pₜ is the transmit power of the transceiver, Gₜ and Gᵣ are the gain values of the transceiver and the measuring machine antenna respectively, and Pₛ is the lowest operable power of the measuring machine.

5. The device of claim 1, wherein a frequency band of the vertical polarization continuous wave signal is 1-2 GHZ.

6. The device of claim 1, wherein a width of the microstrip line is greater than the width of opening in the double split ring resonator.

7. The device of claim 1, wherein the inlet and the outlet are disposed symmetrically on both sides of the liquid container.

8. The device of claim 1, wherein a characteristic impedance of the microstrip line is 50 Ohm.

9. The device of claim 1, wherein the liquid container is made of quartz glass.

10. A contactless and wireless device for measuring solution concentration, comprising:
a measuring machine including a vertical polarization antenna, a horizontal polarization antenna, a circulator, a load and a contactless measurement means for containing solution to be measured, the contactless measurement means including a liquid container and a microstrip defected ground structure, the liquid container being disposed on the microstrip defected ground structure, the liquid container having an inlet and an outlet, the microstrip defected ground structure including a microstrip line and a double split ring resonator, a width of the microstrip line being greater than a width of opening in the double split ring resonator, two ends of the microstrip line forming a first port and a second port respectively, the vertical polarization antenna and the vertical polarization antenna being connected to the first port via the circulator, the second port being connected to the load; and
a transceiver unit including a transceiver and a dual-polarization receive-transmit antenna connected in communication;
wherein the transceiver transmits a vertical polarization continuous wave signal via the dual-polarization receive-transmit antenna, the vertical polarization antenna receives the vertical polarization continuous wave signal, the vertical polarization continuous wave signal enters the solution to be measured via the circulator and is then returned into the circulator, and is converted into a horizontal polarization continuous wave signal by the horizontal polarization antenna, the dual-polarization receive-transmit antenna receives the horizontal polarization continuous wave signal, to obtain a power ratio S11 between the horizontal polarization continuous wave signal and the vertical polarization continuous wave signal, and the concentration of the solution to be measured is calculated according to the variation of a resonance point of S11.
